(19) United States
(12) Patent Application Publication
(10) Pub. No.: US 2023/0337772 A1
(43) Pub. Date: Oct. 26, 2023

(54) METHOD AND TEXTILE USED FOR COLLECTING MICROPLASTICS FROM WATER

(71) Applicant: Alexis Piascik, Cincinnati, OH (US)

(72) Inventor: Alexis Piascik, Cincinnati, OH (US)

(21) Appl. No.: 18/137,690

(22) Filed: Apr. 21, 2023

Related U.S. Application Data
(60) Provisional application No. 63/333,692, filed on Apr. 22, 2022.

(51) Int. Cl. A41D 31/10; A41H 43/04; B01D 39/08; B32B 5/02; B32B 5/26; B32B 7/05; C02F 1/00

(52) U.S. Cl. CPC A41D 31/10; A41H 43/04; B01D 39/083; B32B 5/024; B32B 5/026; B32B 5/028; B32B 5/2795; B32B 5/26; B32B 7/05; C02F 1/001; B01D 2239/0283; B01D 2239/0609; B01D 2239/0613; B01D 2239/0672; B01D 2239/1216; B32B 2250/03; B32B 2250/20; B32B 2262/0261; B32B 2262/0207; B32B 2262/128; B32B 2262/132; B32B 2262/0276; B32B 2307/7375; B32B 2307/726; B32B 2437/00; C02F 2101/30

(57) ABSTRACT

A textile and a method of making the same comprising a microplastic collection layer, a microplastic capture layer, and a water resistant protection layer. The microplastic collection outer layer includes a plurality of openings therein for collecting microplastics from a body of water. The microplastic attraction and capture middle layer attracts and captures the microplastics collected by the microplastic collection outer layer. The water resistant protection layer protects a wearer's skin against the microplastics captured by the microplastic attraction and capture middle layer.

### CROSS REFERENCE TO RELATED APPLICATION

This application claims the benefit of U.S. Provisional Application No. 63/333,692, filed Apr. 22, 2022, the disclosure of which is hereby incorporated herein by reference in its entirety.

### TECHNICAL FIELD

The disclosed technology generally relates to a textile that collects microplastic debris as the textile is moved through a liquid.

### BACKGROUND

Plastic is the most abundant debris found in the ocean. Large pieces of plastic debris do not break down but rather break up into smaller pieces of debris called microplastics. Microplastics are small pieces of plastic five millimeters in length or less. Although microplastics are small, they still have all of the same properties as larger pieces of plastic and all of the same dangers, such as releasing harmful chemicals into the surrounding area, threatening ocean and human health, food safety and quality, and contributing to climate change. Microplastics have contaminated some of the most remote places in the world, including the Pyrenees Mountains and the Mariana Trench. Furthermore, microplastics can be found in tap water, beer, salt, inside fish and marine life, have been detected in the placentas of newborn babies, and have even been found in the bloodstream of humans.

Microfibers are a subset of microplastics with all the same dangers and are found in all of the same locations as microplastics. However, instead of breaking off from familiar pieces of plastic litter, such as water bottles or fishing nets, microfibers come from synthetic fabrics. Synthetic fabrics, such as polyester, are made from the same base components as single-use plastics, such as from polyurethane. Similar to single-use plastics, synthetic fabrics do not break down; they break up into tiny pieces of microfibers. Five millimeters in length or less, microfibers resemble the components found in the lint filter of a dryer or a dust bunny and enter the waterways every time these synthetic fabrics are manufactured, worn, or washed.

Currently there are no microplastic removal methods available to the masses, and only a few industrial methods in development. In 2019, an Irish teenager won the 2019 Google Science Fair by inventing a method to remove microplastics from water using a magnetic liquid called ferrofluid. In 2021, a team of microbiologists from the Hong Kong Polytechnic University presented preliminary findings on the use of engineered bacterial biofilms to capture microplastics in polluted water. However, despite the progress researchers have made, the methods in development to remove microplastics from water are for large scale industrial use, and they are not designed for use by typical consumers.

In addition to advances in the methods of removing microplastics from water, there are currently microfiber filters on the market that capture microfibers from washing machines. These filters can be installed after-market on washing machines or inserted in a washing machine with a load of laundry. These filters prevent new microfibers from entering waterways, but do not remove the existing microfibers currently in oceans or other bodies of water.

Presently, consumer trends indicate that consumers, especially younger consumers, are taking steps to be more sustainable, including using sustainability as a purchase criterion and considering the environmental footprint of a company and its products. However, consumers want to be presented with attainable ways of sustainable living without doing much work to access them; they view it not as a responsibility of the consumer but more as a responsibility of the designer.

In the United States, an estimated 91 million people over the age of sixteen swim in rivers, lakes, and oceans every year. Many of those swimmers are also the consumers that want to be more sustainable. Tackling microplastic pollution in these bodies of water would aid in the sustainability process. The existence of a textile that can passively collect microplastic debris as you wear or use said textile would allow consumers to assist in cleaning up various bodies of water with minimal additional effort by the consumer.

What is needed, therefore, is a textile that can be worn or used in various bodies of water that passively collects microplastic debris as the textile moves through the water.

### BRIEF DESCRIPTION OF THE DRAWINGS

Various embodiments will become better understood with regard to the following description, appended claims and accompanying drawings wherein:

FIG. 1 is an exploded front perspective view of the three layers of one embodiment of the textile of the present disclosure;

FIG. 2 is a zoomed-in, top-down view of one embodiment of the construction pattern of an outer layer of one embodiment of the textile of the present disclosure;

FIG. 3 is a front perspective view of two layers of one embodiment of the textile of the present disclosure fused together by ultrasonic welding;

FIG. 4 is a front perspective view of three layers of one embodiment of the textile of the present disclosure fused together by ultrasonic welding;

FIG. 5 is an exploded cross-sectional side view of three layers of one embodiment of the textile of the present disclosure showing how microplastic debris of different shapes and sizes can enter, become trapped, and be kept away from direct skin contact if the textile is being worn by a mammal; and

FIG. 6 is an illustrative diagram showing the overall problem the textile of the present disclosure is solving.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings, wherein like numbers indicate the same or corresponding elements throughout the views. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, it should be understood that unless otherwise specified or required by context, any explicit or implicit ordering of steps performed in the execution of a method does not imply that those steps must be performed in the order presented but instead may be performed in a different order or in parallel.

Microfibers are a type of microplastic. When used herein the terms “microplastic,” “microplastic debris,” “microfiber,” and “microfiber debris” are interchangeable to the extent that the terms are referencing debris made of microplastic.

The present disclosure allows consumers to passively clean microplastics, particularly microfibers, from various bodies of water that said consumer wears or uses the textile 100 in. The present disclosure allows consumers an affordable and accessible way to assist with cleaning up damaging microplastic debris from the environment. While the textile 100 does not provide a mass solution to completely cleaning microplastic debris from large bodies of water, the textile 100 will allow everyday consumers to help with an already occurring problem without much effort from the consumer. The textile 100 of the present disclosure allows consumers to be a part of the solution rather than part of the problem.

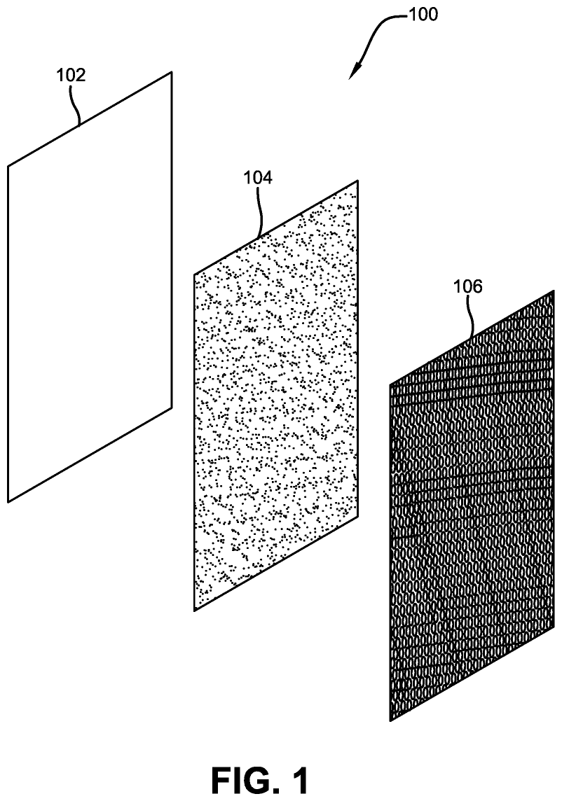

Turning now to the figures, FIG. 1 shows an exploded front perspective view of a textile 100 of one embodiment that utilizes three distinct layers, an inner layer 102, a middle layer 104, and an exterior layer 106. The textile 100 is a wearable filter that accomplishes three functions: attraction, capture, and protection. The microplastic debris must be attracted to the textile, captured in a way that the microplastic debris will not escape until desired, and kept away from direct skin contact. In one or more embodiments, the textile 100 can be used in various items typically used in water, including apparel, flotation devices, water floats or tubes, and water shoes. In one or more embodiments, the textile 100 can make up the entire item, or just a portion thereof In one or more embodiments, the textile 100 can be made into various apparel items or garments that are typically worn in water by consumers, including swimwear, rash guards, shirts, shorts, and hats. It should be understood that as used herein the terms “textile” and “wearable textile” are interchangeable and should not be treated as limiting when using “wearable textile” instead of “textile.”

In one or more embodiments, the inner layer 102 is made from a material having water-resistant properties, antimicrobial properties, 4-way stretch, or a combination thereof. In one or more embodiments, the inner layer 102 is selected from a material selected from the group consisting of tricot, interlock, rib knit, swimwear lining, nylon, spandex, or combinations thereof. In one or more embodiments, the inner layer 102 is made from 88% recycled nylon and 12% spandex.

In one or more embodiments, the middle layer 104 is made from a material having high pile, multifilament fibers, or combinations thereof. In one or more embodiments, the middle layer 104 is selected from a material selected from the group consisting of pile weave, pile knit, spacer fabric, microfiber cloth, French terry, terrycloth, bicomponent fibers, polyamide, polyester, or combinations thereof. In one or more embodiments, the middle layer 104 is made from 55% of a bicomponent fiber (which is 83% polyester and 17% polyamide) and 45% of a polyester microfiber cloth.

In one or more embodiments, the exterior layer 106 is made from a material having a suitable number of openings therein. In one or more embodiments, the exterior layer 106 is selected from a material selected from the group consisting of mesh, athletic mesh, sport mesh, micro mesh, eyelet mesh, tricot mesh, fishnet mesh, polyester mesh, or combinations thereof In one or more embodiments, the exterior layer 106 is made from 100% recycled polyester mesh.

In one or more embodiments, the material that is utilized to make the inner layer 102, the middle layer 104, and/or the exterior layer 106 are made from entirely natural or recycled fibers. In one or more embodiments, the natural or recycled fibers were turned into yarn, and the yarn was then turned into the fabric that was ultimately used to make the inner layer 102, the middle layer 104, and/or the exterior layer 106. In addition to the specific materials listed above for the inner layer 102, the middle layer 104, and/or the exterior layer 106, in one or more embodiments, the inner layer 102, the middle layer 104, and/or the exterior layer 106 are made from natural fibers including, but are not limited, to wool, bamboo, soy, algae, banana leaf, cotton, and hemp.

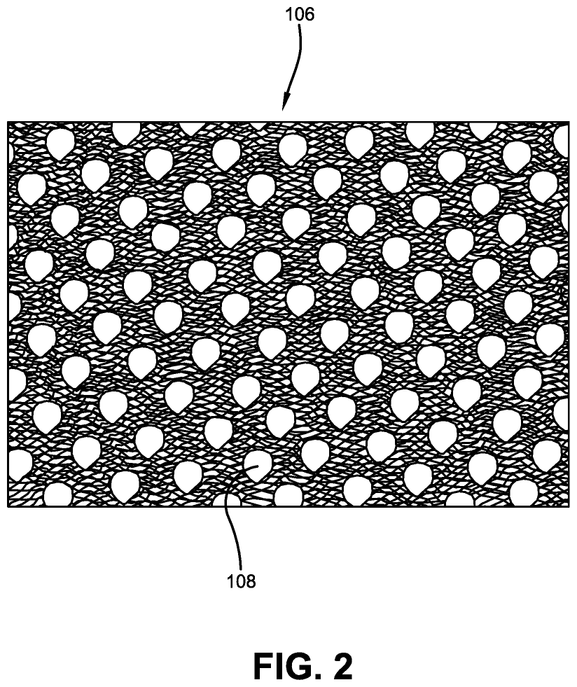

Turning now to FIG. 2, that figure shows a zoomed-in, top-down view of the construction pattern of the outer layer of the textile 106 having a plurality of openings 108 therein. The plurality of openings 108 may be implemented with varying sizes and shapes depending upon a particular use and purpose. In one or more embodiments, each opening 108 of the plurality of openings 108 can have different sizes and shapes within the same textile 100. As an example, an opening 108 of the plurality of openings 108 may be square, rectangular, circular, hexagonal, or any other geometric shape through which the targeted materials may pass in at least one orientation. An opening 108 of the plurality of openings 108 may have a width (e.g., diameter, diagonal) selected to allow targeted materials of certain sizes to pass through, while preventing other objects (e.g., floating plant material, a user's finger) from passing through, and for example may have a width of between about 0.5 mm and about 3.5 mm. In one or more embodiments, an opening 108 of the plurality of openings has a width of about 1 mm, which is particularly advantageous in allowing the passage and receipt of the most prevalent targeted materials, though such a width may vary based upon a particular body of water and/or targeted material.

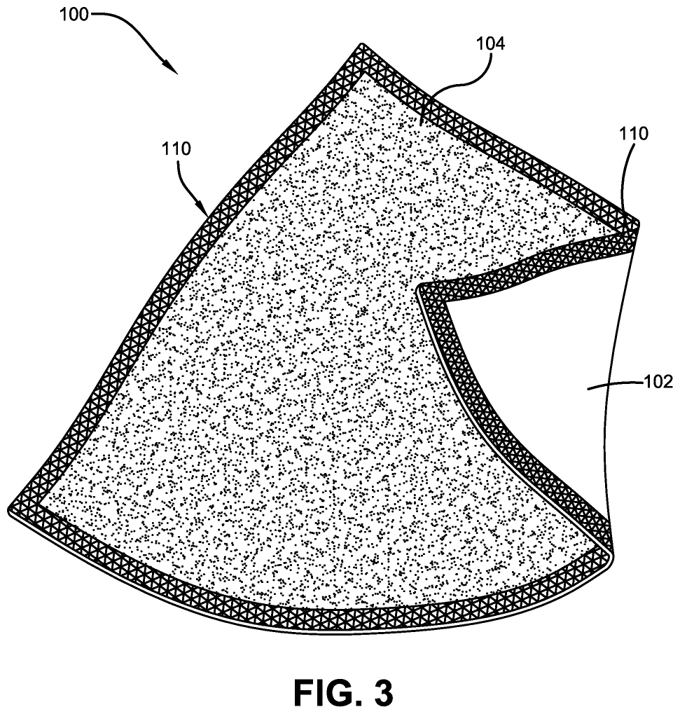

FIG. 3 shows a front perspective view of the inner layer 102 and a middle layer 104 of the textile 100 fused together by ultrasonic welding. In one or more embodiments, the inner layer 102 of textile 100 and the middle layer 104 of the textile 100 are fused together along the edges of the two fabrics through ultrasonic welding 110 to produce a two-layered textile 100. In one or more embodiments, the inner layer 102 of the textile 100 and the middle layer 104 of the textile 100 can be sewn together using thread. However, ultrasonically welding the inner layer 102 and a middle layer 104 together creates a textile 100 without the need for sewing, which eliminates the need for thread, and cuts down on man-hours required for construction of a wearable textile 100. In one or more embodiment, the inner layer 102 and a middle layer 104 are fused together using an ultrasonic welder. A range of parameters of the ultrasonic welder can be used to weld the fabrics together. In one or more embodiment, the ultrasonic welder used to weld together the inner layer 102 and a middle layer 104 utilizes between about 325 and about 450 watts, at a speed of between about 1.5 and about 2.5 meters/minute, at a pressure of between about 250 and about 350 Newtons, and at a height, wherein height refers to the distance between the two metal plates doing the welding, of between 0.4 and 0.6 millimeters. In one embodiment, the ultrasonic welder used to weld together the inner layer 102 and a middle layer 104 utilizes: 350 watts, at a speed of 2.0, at a pressure of 300, and at a height of 0.6.

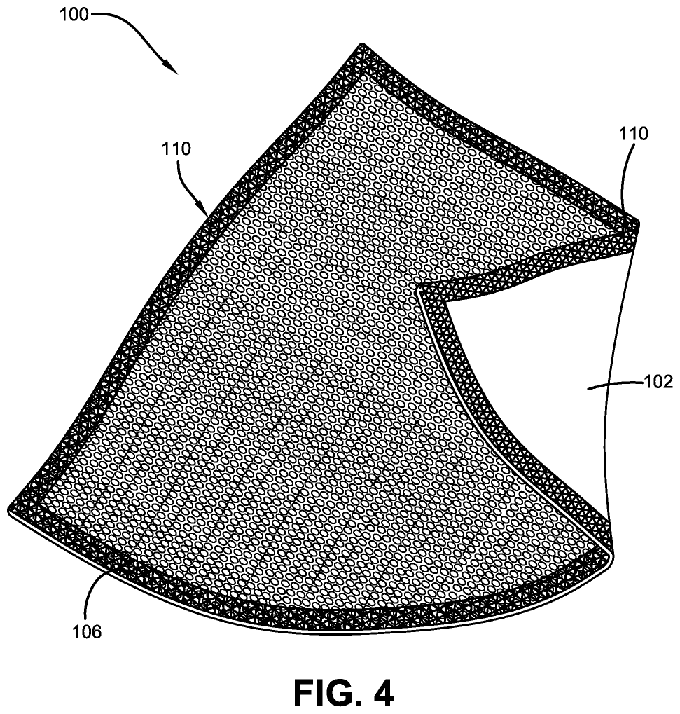

FIG. 4 shows a front perspective view of an inner layer 102, a middle layer 104, and an exterior layer 106 of the textile 100 fused together by ultrasonic welding 110. Middle layer 104 is not visible in FIG. 4 as it is sandwiched between inner layer 102 and exterior layer 106. The inner layer 102, the middle layer 104, and the outer layer 106 are fused together along the edges of the three fabrics through ultrasonic welding 110 to produce the textile 100. In one or more embodiments, the inner layer 102, the middle layer 104, and the outer layer 106 can be sewn together with thread. A range of parameters of the ultrasonic welder can be used to weld the fabrics together. In one or more embodiment, the ultrasonic welder used to weld together the inner layer 102 and a middle layer 104 utilizes between about 325 and about 450 watts, at a speed of between about 1.5 and about 2.5 meters/minute, at a pressure of between about 250 and about 350 Newtons, and at a height of between 0.4 and 0.6 millimeters. In one embodiment, the ultrasonic welder used to weld together the inner layer 102 and a middle layer 104 utilizes: 350 watts, at a speed of 2.0, at a pressure of 300, and at a height of 0.6. These parameters for the ultrasonic welder are particularly vital when working with the outer layer 106, which is made from a mesh material, due to the decreased surface area and unique textile construction of mesh materials.

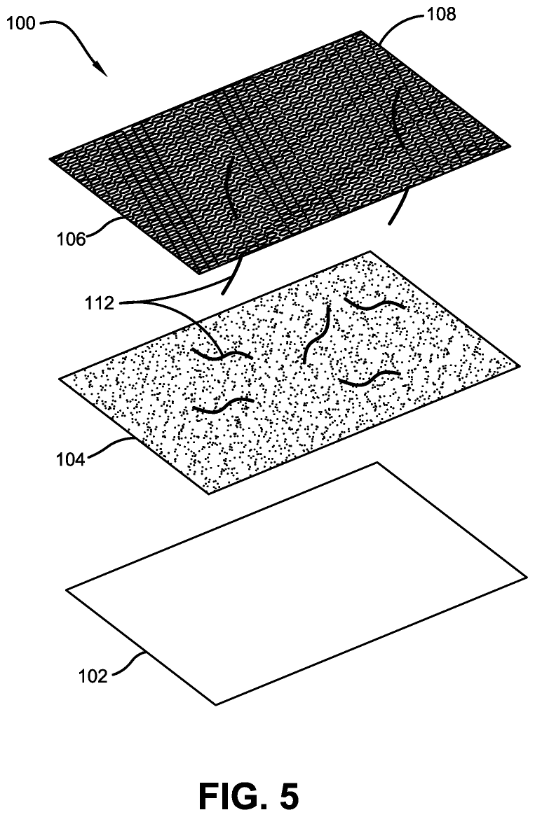

FIG. 5 shows an exploded cross-sectional side view of an inner layer 102, a middle layer 104, and an exterior layer 106 of the textile 100 and how microfiber debris 112 of different shapes and sizes can enter through exterior layer 106, become trapped between the exterior layer 106 and the middle layer 104, and be kept away from direct skin contact by inner layer 102 if textile 100 is worn by a mammal. The inner layer 102 protects the wearer's skin from direct contact with the microplastic debris 112. The middle layer 104 attracts the microplastic debris 112 from the water, wherein the microplastic debris 112 makes its way through the exterior layer 106 through the openings 108 and is captured between the middle layer 104 and the exterior layer 106 until such time that the user desires to remove the microplastic debris 112 from the textile 100.

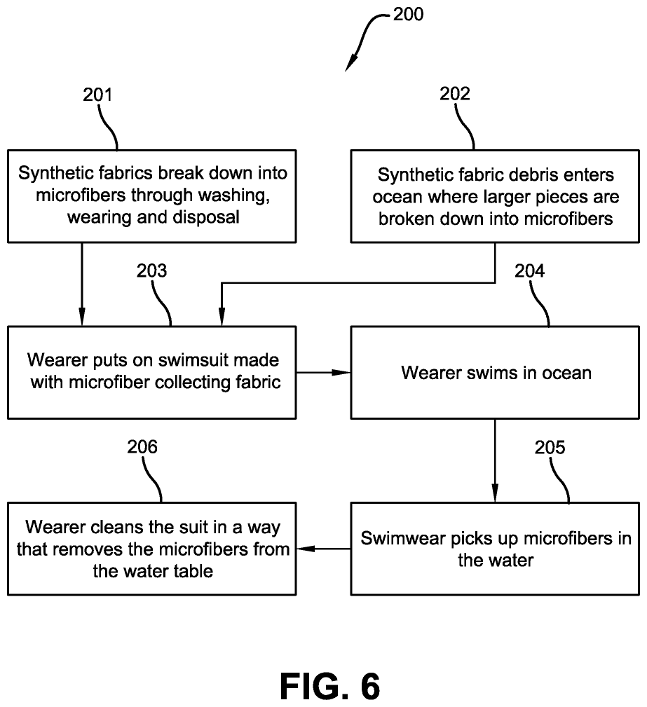

Finally, FIG. 6 shows an illustrative diagram 200 showing how the textile 100 of the present disclosure will be utilized to remove microfiber debris 112 from a body of water. First, synthetic fabrics break down into microfibers through washing, wearing, and disposal 201. Alternatively, synthetic fabric debris enters oceans or other bodies of water where larger pieces are broken down into microfibers 202. In one or more embodiments wherein the textile 100 is used in swimwear, the swimwear is put on in a step 203. When a user decides to utilize textile 100 in an ocean or other body of water, the user will proceed to swim or perform other activities in an ocean or other body of water 204. As the user is swimming or performing other activities, the textile 100 filters the water and collects the microplastic debris in the ocean or other body of water 205. Finally, after the user is done swimming, the user cleans the swimwear in a way that removes the microplastic debris 112 from the swimwear 206.

Cleaning the textile 100 can be done in various ways, including through a washing machine; provided, however, any such method should have a microfiber filter attached to the water drainage system. The increased force of a washing machine cycle releases the microplastic debris 112 from the textile 100, thereby allowing a microfiber filter to catch the released microplastic debris 112. Microfiber filters for washing machines prevent more fibers from entering the ecosystem. There are various after-market filters that can be installed on a washing machine or drainage system, and if installation cannot be done, there are also filters that can be placed in the washing machine with the textile 100 to collect the released microplastic debris 112. A washing machine filter collects fibers much like a dryer lint screen does for lint. Once the filter is full, the user can dispose of the collected microfiber debris 112 in various ways depending on the manufacturer of the filter and proximity to available textile recycling programs.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended that the scope of the disclosure will be defined by the claims appended hereto.

What is claimed is:

1. A fabric comprising:
a water resistant inner layer;
a microplastic attraction and capture middle layer; and
a microplastic collection outer layer, wherein the microplastic collection outer layer contains a plurality of openings therein.

2. The fabric of claim 1, wherein the water resistant inner layer is selected from a material selected from the group consisting of tricot, interlock, rib knit, swimwear lining, or combinations thereof

3. The fabric of claim 2, wherein the material is made from a fiber selected from the group consisting of nylon, spandex, or combinations thereof.

4. The fabric of claim 1, wherein the microplastic attraction and capture middle layer is made from a material selected from the group consisting of pile weave, pile knit, spacer fabric, microfiber cloth, French terry, terrycloth, or combinations thereof.

5. The fabric of claim 4, wherein the material is made from a fiber selected from the group consisting of bicomponent fibers, polyamide fibers, polyester fibers, or combinations thereof.

6. The fabric of claim 1, wherein the microplastic collection outer layer is made from a material selected from the group consisting of mesh, athletic mesh, sport mesh, micro mesh, eyelet mesh, tricot mesh, fishnet mesh, polyester mesh, or combinations thereof.

7. The fabric of claim 1, wherein the water resistant inner layer, the microplastic attraction and capture middle layer; and the microplastic collection outer layer is made from a material that is made from natural or recycled fibers.

8. The fabric of claim 1, wherein the plurality of openings of the microplastic outer layer have a width of between about 0.5 mm and about 3.5 mm.

9. The fabric of claim 1, wherein outer edges of the water resistant inner layer, outer edges of the microplastic attraction and capture middle layer, and outer edges of the microplastic collection outer layer are fused together by ultrasonic welding.

10. A garment comprising:
a microplastic collection outer layer having a plurality of openings therein for collecting microplastics from a body of water;
a microplastic attraction and capture middle layer for attracting and capturing the microplastics collected by the microplastic collection outer layer; and
a water resistant inner layer for protection of a wearer's skin against the microplastics captured by the microplastic attraction and capture middle layer.

11. The garment of claim 10, wherein the water resistant inner layer is selected from a material selected from the group consisting of tricot, interlock, rib knit, swimwear lining, or combinations thereof

12. The garment of claim 11, wherein the material is made from a fiber selected from the group consisting of nylon, spandex, or combinations thereof

13. The garment of claim 10, wherein the microplastic attraction and capture middle layer is made from a material selected from the group consisting of pile weave, pile knit, spacer fabric, microfiber cloth, French terry, terrycloth, or combinations thereof.

14. The garment of claim 13, wherein the material is made from a fiber selected from the group consisting of bicomponent fibers, polyamide fibers, polyester fibers, or combinations thereof

15. The garment of claim 10, wherein the microplastic collection outer layer is made from a material selected from the group consisting of mesh, athletic mesh, sport mesh, micro mesh, eyelet mesh, tricot mesh, fishnet mesh, polyester mesh, or combinations thereof.

16. The garment of claim 10, wherein the water resistant inner layer, the microplastic attraction and capture middle layer; and the microplastic collection outer layer is made from a material that is made from natural or recycled fibers.

17. The garment of claim 10, wherein the plurality of openings of the microplastic outer layer have a width of between about 0.5 mm and about 3.5 mm.

18. The garment of claim 10, wherein outer edges of the water resistant inner layer, outer edges of the microplastic attraction and capture middle layer, and outer edges of the microplastic collection outer layer are fused together by ultrasonic welding.

19. A method of removing microplastics from a body of water comprising:
a. placing a microplastic collecting fabric within the body of water, wherein the microplastic collecting fabric comprises a water resistant inner layer; a microplastic attraction and capture middle layer; and a microplastic collection outer layer, wherein the microplastic collection outer layer contains a plurality of openings therein;
b. collecting microplastics through the plurality of openings in the microplastic collection outer layer;
c. capturing microplastic with the microplastic attraction and capture middle layer; and
d. cleaning the microplastic collecting fabric to remove the microplastics from the microplastic collecting fabric.

20. The method of claim 19, wherein the step of cleaning includes placing the microplastic collecting fabric within a washing machine having a microplastic filter attached to a water drainage system of the washing machine.
